(19) United States
(12) Patent Application Publication
(10) Pub. No.: US 2001/0024959 A1
(43) Pub. Date: Sep. 27, 2001

(54) Antenna arrangement

(75) Inventors: Kevin R. Boyle, Horsham (GB); Peter J. Massey, Horley (GB)

Correspondence Address: Corporate Patent Counsel, U.S. Philips Corporation, 580 White Plains Road, Tarrytown, NY, 10591, US

(73) Assignee: U.S. Philips Corporation

(21) Appl. No.: 09/805,482

(22) Filed: Mar. 13, 2001

(30) Foreign Application Priority Data
Mar. 23, 2000 (GB) 0006956.7

(51) Int. Cl. H04M 1/00

(52) U.S. Cl. 455/550; 455/269; 455/193.1

(57) ABSTRACT

A wireless terminal has an antenna arrangement including one or more antennas (102a, 102b) designed to reduce substantially currents flowing on ground conductors (104a, 104b, 104c) within the device. In known terminals, these currents generate radiation of unwanted polarisations and radiation in unwanted directions, and can also reduce radiation efficiency.

The antenna arrangement of the present invention employs antennas (102a, 102b) having an electrical length of slightly more than half a wavelength. The feed currents drawn from the ground conductors (104a, 104b, 104c) are then out of phase with the current flowing on most of the antenna and therefore cancel with induced currents. The total current flowing in the ground conductors (104a, 104b, 104c) is reduced, thereby minimising radiation from these conductors and improving overall radiation characteristics. Further, the input impedance of the antenna (102a, 102b) remains reasonable.

The present invention relates to an antenna arrangement for a wireless device, and to a wireless device including such an antenna arrangement.

A wide range of antenna arrangements have been used for wireless devices. Many such devices employ a monopole or similar antenna, having a single-ended feeding arrangement in which a Radio Frequency (RF) source is effectively applied between one end of the antenna and a ground conductor on the device. The ground conductor may take various forms, for example a ground plane on a Printed Circuit Board (PCB) or a metal (or metallised) equipment case. In such an arrangement the current flowing into the antenna (which generates the required radiation) is counter-balanced by current flowing on the ground conductor.

The current flowing on the ground conductor is randomly-orientated, depending on the geometry of the conductor, and may cause radiation of unwanted polarisation in unwanted directions. Further, proximity of the conductor to lossy components can reduce the efficiency of the system, while the presence of RF currents in the ground conductor can cause de-sensitisation of a receiver as well as Electro-Magnetic Compatibility (EMC) related problems.

A range of different measures have been proposed to reduce the current on the ground conductor, including:

Use of a sleeve dipole, which is essentially a dipole antenna where the feed is provided coaxially through one arm of the dipole to its central feed point, see for example Mobile Antenna Systems Handbook, K Fujimoto and J R James, Artech House, 1994, pages 203 to 210. This requires a large structure.

A monopole having a length of ⅜ of a wavelength. Such an antenna has a low current at its base, but a reasonable impedance. However, currents coupled from the ground conductor to the base of the antenna reduce its performance significantly.

A counterpoise, which is an additional section of ground conductor added to take most of the ground current, often in the form of a wire winding. Such an antenna is disclosed in EP-A-0 635 898. Although the ground current is not reduced, it is made more predictable.

An antenna comprising a pair of series-coupled monopole elements, having electrical lengths of a half and a quarter wavelength respectively, coupled to ground via a transmission line element. Such an antenna is disclosed in U.S. Pat. No. 4,138,681. Although effective, it is rather bulky and complex.

An antenna fed via a pair of coils, disclosed in U.S. Pat. No. 5,583,520. Again, although effective the arrangement is bulky and complex.

An object of the present invention is to provide an improved antenna arrangement for reducing the current flowing in the ground conductor.

According to a first aspect of the present invention there is provided an antenna arrangement for a wireless device, the device comprising at least one ground conductor and the antenna arrangement comprising at least one antenna, wherein the or each antenna has an electrical length of more than half a wavelength, the electrical length being selected so that the total current in each of the at least one ground conductors is substantially minimised.

According to a second aspect of the present invention there is provided a wireless device including an antenna arrangement made in accordance with the present invention.

The present invention is based upon the recognition, not present in the prior art, that use of an antenna that is electrically longer than half a wavelength results in the counterpoise current drawn from the ground conductor to be out of phase with the current induced on that conductor by the antenna. This results in a cancellation of currents in the ground conductor and minimises unwanted radiation from it. The electrical length of an antenna should be determined by reference to the current distribution on the antenna rather than the physical length of the antenna.

Because the antenna is used beyond resonance, a reasonable input impedance can be achieved. Typically, a physically-shortened electric field antenna such as a normal mode helix or meander line would be used.

Embodiments of the present invention will now be described, by way of example, with reference to the accompanying drawings, wherein:

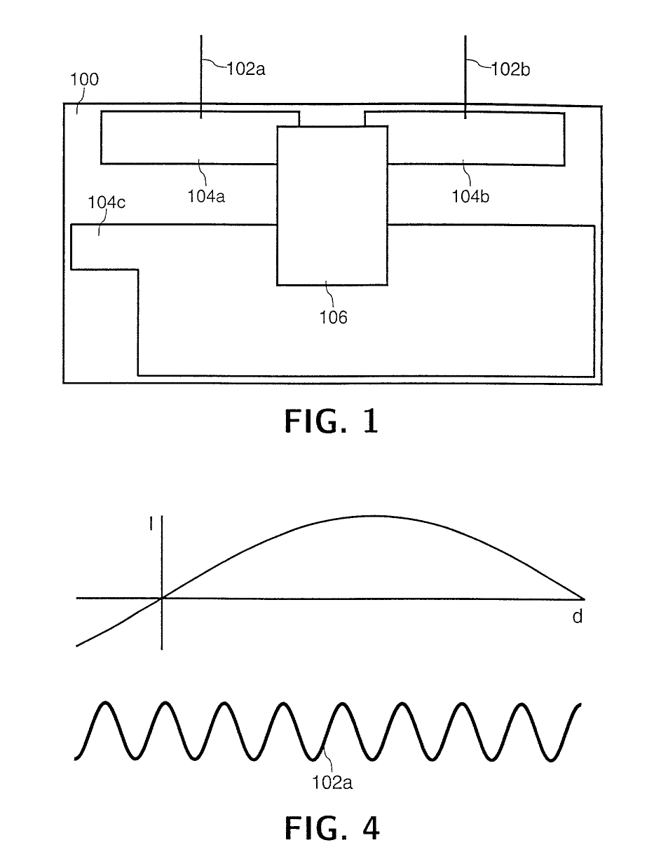

FIG. 1 is a schematic diagram of the layout of a DECT base station;

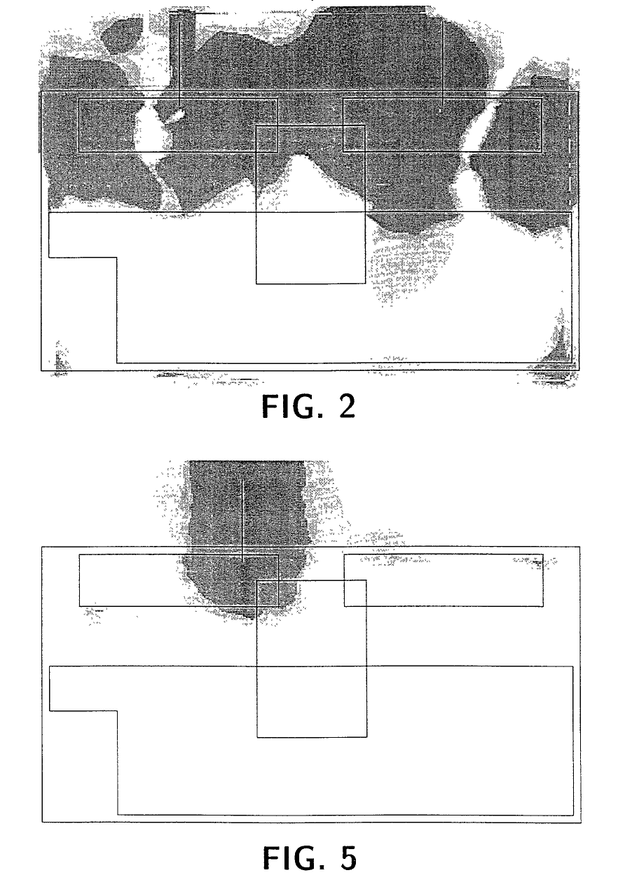

FIG. 2 is a plot of the magnitude of the electric field in the vicinity of the base station's PCB for a conventional antenna arrangement with one antenna activated;

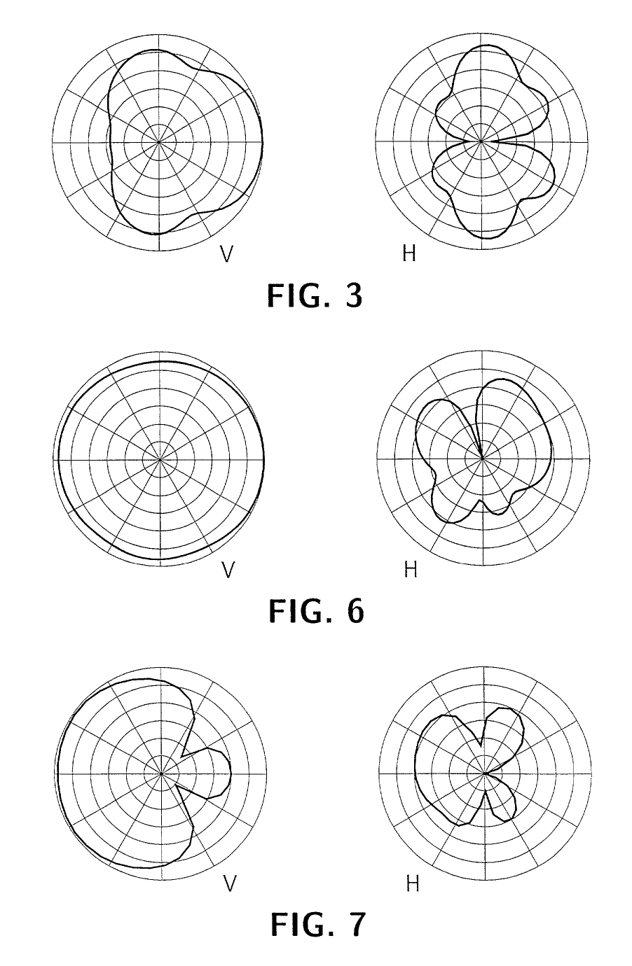

FIG. 3 shows azimuthal radiation patterns for vertical (V) and horizontal (H) polarisations from the base station with one conventional antenna activated;

FIG. 4 is a plot of the current (I) along the length (d) of an improved helical antenna arrangement;

FIG. 5 is a plot of the magnitude of the electric field in the vicinity of the base station's PCB for an improved antenna arrangement comprising a single antenna;

FIG. 6 shows azimuthal radiation patterns for vertical (V) and horizontal (H) polarisations from the base station having an improved antenna arrangement; and

FIG. 7 shows azimuthal radiation patterns for vertical (V) and horizontal (H) polarisations from the base station with two improved antennas fed with a 90° phase difference.

In the drawings the same reference numerals have been used to indicate corresponding features.

The present invention will be described with reference to an embodiment of a DECT (Digital Enhanced Cordless Telecommunications) base station, shown schematically in FIG. 1. The base station comprises a plastic case (not shown), mounted inside which is a PCB (Printed Circuit Board) 100 having first and second antennas 102a, 102b mounted on and projecting from it. There are three major areas of ground conductor 104a, 104b, 104c on the PCB itself, together with the metallic case 106 of an RF module which also acts as a ground conductor.

In use the case is mounted with the PCB 100 and antennas 102a, 102b in a vertical position. The antennas 102a, 102b are vertically polarised and operate as a spatial diversity pair, having a separation of 11 cm, or approximately 0.7 wavelengths at a DECT frequency of 1890 MHz. (It should be noted that the present invention is equally applicable to arrangements having a single antenna.) With one of the antennas 102a, 102b operating the expected radiation pattern is substantially omnidirectional in the horizontal (azimuthal) plane and vertically polarised.

Electromagnetic simulations of this base station were performed using a finite element electromagnetic simulation package. In the simulations of the unmodified base station, the antennas 102a, 102b were both modelled as quarter-wavelength monopoles, having a length of approximately 4 cm at 1890 MHz. FIG. 2 shows the magnitude of the electric field in a plane parallel (and close) to the plane of the PCB. Higher field strengths are indicated by darker shading, lower field strengths by lighter shading. This plot gives a good indication of where currents flowing on the ground conductors contribute to radiation from the base station.

In this simulation the second antenna 102b is active while the first antenna 102a has been detuned by the application of an open circuit at its feed point. However, there is significant current flow in the ground conductors, particularly the upper ground planes 104a, 104b, which generates significant radiation. The radiation patterns shown in FIG. 3 illustrate this effect. Grid lines in this figure (and in subsequent plots of radiation patterns) are at 5 dB spacings, with the outer grid line normalised to the maximum gain of the vertically polarised radiation pattern (V). This pattern is far from omnidirectional, while the horizontally polarised pattern (H) shows a similar level of radiation to the vertically polarised. It was also found that a similar level of horizontally polarised radiation was transmitted in the zenith direction, which radiation contributes significantly to reduced system efficiency. The horizontal polarisation can only be produced by currents flowing on the ground conductors (since the second antenna 102b produces substantially vertically polarised radiation), indicating that the presence of these currents on the ground conductors is a significant problem.

This problem can be solved in accordance with the present invention by arranging for each antenna 102a, 102b to have an electrical length of more than half a wavelength. The electrical length of the antenna is preferably between 0.5 and 0.8 wavelengths, since if longer antennas are used significant currents are again induced in the ground conductors.

Simulations of the base station were performed with a single helical antenna 102a, which determined that the optimum electrical length was approximately 0.6λ. FIG. 4 shows the approximate distribution of current (I) along the length (d) of a helical antenna 102a, showing a sinusoidal current distribution with the feed current (at the left-hand end of the plot) in anti-phase to the current on the majority of the antenna 102a. The antenna is formed of about 8.5 turns, with a diameter of about 0.4 cm and a pitch of about 0.8 cm. The dimensions were chosen to ensure that the radiation was predominantly linearly-polarised, with a relatively broad bandwidth. The impedance of the antenna feed had a reasonable value of approximately 20-j150 ohms.

The effect of the improved antenna arrangement on the current distribution on the ground conductors is dramatic. Further simulations were performed on a base station having a single helical antenna 102a, of the dimensions discussed above, with the results illustrated in FIG. 5. This shows the magnitude of the electric field in the same plane as that used in FIG. 2, with the shadings having the same meaning too. The only significant electric field is now close to the antenna 102a itself, indicating that the currents on the ground conductors 104a, 104b, 104c have been greatly reduced.

FIG. 6 shows the azimuthal radiation patterns resulting from the improved antenna arrangement. The vertically polarised radiation (V) is now substantially omni-directional, with a peak to peak ripple of less than 2 dB. The horizontally polarised radiation (H) is now very much less significant, on average approximately 10 dB below the vertical polarisation.

Use of the improved antenna arrangement with two antennas 102a, 102b in a diversity arrangement has also been investigated. Simulations were performed with two helical antennas 102a, 102b, of the type described above, separated by 6 cm, which is approximately ⅜ of a wavelength at 1890 MHz. By feeding the antennas as a two element array with equal powers and a phase difference between the antennas of 90°, directional beams can be obtained. Further details of how to feed two antenna elements as an effective array with minimum correlation between the beams are given in our co-pending patent application (our reference PHGB 000033).

The resultant patterns are shown in FIG. 7 for vertical (V) and horizontal (H) polarisations. It can be seen that good directionality is obtained for the wanted vertical polarisation. Suppression of the unwanted horizontal polarisation by an average of at least 10 dB, by cancellation of direct and coupled currents, is therefore maintained when the antennas 102a, 102b are fed as an array.

As well as the helical and monopole antennas used in the embodiments of the present invention described above, a range of physically-shortened electric antennas could be used. Such antennas are monopole or dipole-like antennas that are physically smaller than their electrical length, and receive predominantly the electric field. An example of such an alternative antenna is a meander-line antenna, which can be printed on a PCB 100 for ease of construction. By reducing the contribution to the radiation pattern from the ground conductors 104a, 104b, 104c, 106 the polarisation and radiation pattern can be controlled more precisely for a range of different antenna designs.

The present invention can be applied to any wireless device with an unbalanced antenna feed. It could even apply to balanced antennas where there are significant common mode currents (as is often the case due to geometric asymmetry). Typical examples of suitable applications are wireless data cards (PCMCIA and similar), mobile phones (where the ground conductor is the EMC shield of the handset) and other wireless consumer communication equipment.

From reading the present disclosure, other modifications will be apparent to persons skilled in the art. Such modifications may involve other features which are already known in the design, manufacture and use of antenna arrangements for wireless equipment, and which may be used instead of or in addition to features already described herein. Although claims have been formulated in this application to particular combinations of features, it should be understood that the scope of the disclosure of the present application also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention. The applicants hereby give notice that new claims may be formulated to such features and/or combinations of features during the prosecution of the present application or of any further application derived therefrom.

In the present specification and claims the word “a” or “an” preceding an element does not exclude the presence of a plurality of such elements. Further, the word “comprising” does not exclude the presence of other elements or steps than those listed.

1. An antenna arrangement for a wireless device, the device comprising at least one ground conductor and the antenna arrangement comprising at least one antenna, wherein the or each antenna has an electrical length of more than half a wavelength, the electrical length being selected so that the total current in each of the at least one ground conductors is substantially minimised.

2. An antenna arrangement as claimed in claim 1, characterised in that the or each antenna is a helical antenna.

3. An antenna arrangement as claimed in claim 1, characterised in that the or each antenna is a monopole antenna.

4. An antenna arrangement as claimed in claim 1, characterised in that the or each antenna is a physically-shortened electric antenna.

5. An antenna arrangement as claimed in any one of claims 1 to 4, characterised in that the electrical length of the or each antenna is between 0.5 and 0.8 wavelengths.

6. An antenna arrangement as claimed in any one of claims 1 to 4, characterised in that the antenna arrangement comprises at least two antennas and further comprises means for feeding each antenna with a signal of suitable amplitude and phase so that the antenna arrangement functions as a directional array.

7. An antenna arrangement as claimed in claim 5, characterised in that the antenna arrangement comprises at least two antennas and further comprises means for feeding each antenna with a signal of suitable amplitude and phase so that the antenna arrangement functions as a directional array.

8. A wireless device including an antenna arrangement as claimed in any one of claims 1 to 4.

9. A wireless device including an antenna arrangement as claimed in claim 5.

10. A wireless device including an antenna arrangement as claimed in claim 6.

11. A wireless device including an antenna arrangement as claimed in claim 7.
